(19) United States
(12) Patent Application Publication
(10) Pub. No.: US 2010/0297395 A1
(43) Pub. Date: Nov. 25, 2010

(54) FIBROUS STRUCTURES COMPRISING DESIGN ELEMENTS AND METHODS FOR MAKING SAME

(76) Inventors: Andre Mellin, Amberley Village, OH (US); Jason Merrill Jones, Lebanon, OH (US); Thomas Timothy Byrne, West Chester, OH (US); Kevin Benson McNeil, Loveland, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/468,523

(22) Filed: May 19, 2009

(51) Int. Cl. B31F 1/07; A47K 10/16; D21H 27/40

(52) U.S. Cl. 428/156; 264/293; 428/195.1; 428/211.1

(57) ABSTRACT

Fibrous structures that include design elements and more particularly to fibrous structures that have a design element having a primary design element and two, different secondary design elements that are associated with one another via the primary design element and methods for making such fibrous structures are provided.

### FIELD OF THE INVENTION

The present invention relates to fibrous structures that comprise design elements and more particularly to fibrous structures that comprise a design element comprising a primary design element and two, different secondary design elements that are associated with one another via the primary design element and methods for making such fibrous structures.

### BACKGROUND OF THE INVENTION

Fibrous structures comprising design elements are known in the art. However, such known fibrous structures exhibit consumer negatives due in part to the nature of the design elements contained thereon. In one example, a known fibrous structure comprises a primary design element and two, identical secondary design elements associated with one another via the primary design element. In addition, there are known fibrous structures that comprise a primary design element and only one secondary design element associated with the primary design element. It has been found that such known fibrous structures do not meet all of the consumers' needs, especially consumers' aesthetic needs, which impact the overall impression by consumers of the fibrous structure

Accordingly, there is a need for a fibrous structure that comprises a primary design element and two, different secondary design elements that are associated with one another via the primary design element, and a method for making such fibrous structures.

### SUMMARY OF THE INVENTION

The present invention fulfills the need described above by providing a fibrous structure comprising a primary design element and two, different secondary design elements that are associated with one another via the primary design element.

It has unexpectedly been found that fibrous structures comprising a primary design element and two, different secondary design elements that are associated with one another via the primary design element at an angle of greater than 100° but less than 180° as measured according to the Secondary Design Element Angle Test Method described herein are consumer preferred over prior art fibrous structures comprising design elements.

In one example of the present invention, a fibrous structure comprising a primary design element and two, different secondary design elements that are associated with each other via the primary design element at an angle of greater than 100° but less than 180° as measured according to the Secondary Design Element Angle Test Method described herein, is provided.

In another example of the present invention, a fibrous structure comprising a first design element comprising a primary design element and two, different secondary design elements that are associated with each other via the primary design element at an angle of greater than 100° to about 150° as measured according to the Secondary Design Element Angle Test Method described herein and a second design element different from the first design element, wherein the second design element comprises a primary design element and two, different secondary design elements that are associated with each other via the primary design element at an angle of greater than 155° to about 175° as measured according to the Secondary Design Element Angle Test Method described herein, is provided.

In still another example of the present invention, a single- or multi-ply sanitary tissue product comprising a fibrous structure according to the present invention, is provided.

In even still another example of the present invention, a method for making a fibrous structure comprising a design element, the method comprising the step of imparting a design element comprising a primary design element and two, different secondary design elements that are associated with each other via the primary design element at an angle of greater than 100° but less than 180° as measured according to the Secondary Design Element Angle Test Method described herein to a fibrous structure, is provided.

In yet another example of the present invention, a fibrous structure comprising a primary design element and two, different secondary design elements associated with the primary design element, wherein the primary design element has a maximum span between any two line element embossments within the primary design element and wherein the ratio of the average distance between centroids of the two secondary design elements from the centroid of the primary design element relative to the primary design element maximum span is at least 0.4 but less than 3, is provided.

Accordingly, the present invention provides a fibrous structure comprising a design element comprising a primary design element and two, different secondary design elements, and a method for making such a fibrous structure.

### BRIEF DESCRIPTION OF THE DRAWINGS

FIG. 1 is a schematic representation of an example of a design element according to the present invention;

FIG. 2 is a schematic representation of another example of a design element according to the present invention;

FIG. 3 is a schematic representation of an example of a fibrous structure according to the present invention;

FIG. 4 is a schematic representation of an example of a design element according to the present invention;

FIG. 5 is a partial, exploded schematic representation of an example of an embossing operation according to the present invention;

FIG. 6 is a schematic representation of another example of a design element according to the present invention;

FIG. 7 is a schematic representation of the primary design element of the design element of FIG. 6;

FIG. 8A is a schematic representation of a secondary design element of the design element of FIG. 6;

FIG. 8B is a schematic representation of the secondary design element of FIG. 8A with centroids identified;

FIG. 9A is a schematic representation of a secondary design element of the design element of FIG. 6;

FIG. 9B is a schematic representation of the secondary design element of FIG. 9A with centroids identified;

FIG. 10 is a schematic representation of the secondary design element of FIG. 8A with its centroid identified;

FIG. 11 is a schematic representation of the secondary design element of FIG. 9A with its centroid identified; and

FIG. 12 is a schematic representation of the design element of FIG. 6 with the centroids of its primary design element and secondary design elements identified.

### DETAILED DESCRIPTION OF THE INVENTION

### Definitions

“Fibrous structure” as used herein means a structure that comprises one or more filaments and/or fibers. In one example, a fibrous structure according to the present invention means an orderly arrangement of filaments and/or fibers within a structure in order to perform a function. Non-limiting examples of fibrous structures of the present invention include paper, fabrics (including woven, knitted, and non-woven), and absorbent pads (for example for diapers or feminine hygiene products).

Non-limiting examples of processes for making fibrous structures include known wet-laid papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous slurry is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

The fibrous structures of the present invention may be homogeneous or may be layered. If layered, the fibrous structures may comprise at least two and/or at least three and/or at least four and/or at least five layers.

The fibrous structures of the present invention may be co-formed fibrous structures. “Fiber” and/or “Filament” as used herein means an elongate particulate having an apparent length greatly exceeding its apparent width, i.e. a length to diameter ratio of at least about 10. In one example, a “fiber” is an elongate particulate as described above that exhibits a length of less than 5.08 cm (2 in.) and a “filament” is an elongate particulate as described above that exhibits a length of greater than or equal to 5.08 cm (2 in.).

Fibers are typically considered discontinuous in nature. Non-limiting examples of fibers include wood pulp fibers and synthetic staple fibers such as polyester fibers.

Filaments are typically considered continuous or substantially continuous in nature. Filaments are relatively longer than fibers. Non-limiting examples of filaments include meltblown and/or spunbond filaments. Non-limiting examples of materials that can be spun into filaments include natural polymers, such as starch, starch derivatives, cellulose and cellulose derivatives, hemicellulose, hemicellulose derivatives, and synthetic polymers including, but not limited to polyvinyl alcohol filaments and/or polyvinyl alcohol derivative filaments, and thermoplastic polymer filaments, such as polyesters, nylons, polyolefins such as polypropylene filaments, polyethylene filaments, and biodegradable or compostable thermoplastic fibers such as polylactic acid filaments, polyhydroxyalkanoate filaments and polycaprolactone filaments. The filaments may be monocomponent or multicomponent, such as bicomponent filaments.

In one example of the present invention, “fiber” refers to papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. Also applicable to the present invention are fibers derived from recycled paper, which may contain any or all of the above categories as well as other non-fibrous materials such as fillers and adhesives used to facilitate the original papermaking.

In addition to the various wood pulp fibers, other cellulosic fibers such as cotton linters, rayon, lyocell and bagasse can be used in this invention. Other sources of cellulose in the form of fibers or capable of being spun into fibers include grasses and grain sources.

“Sanitary tissue product” as used herein means a soft, low density (i.e. <about 0.15 g/cm³) web useful as a wiping implement for post-urinary and post-bowel movement cleaning (toilet tissue), for otorhinolaryngological discharges (facial tissue), and multi-functional absorbent and cleaning uses (absorbent towels). The sanitary tissue product may be convolutedly wound upon itself about a core or without a core to form a sanitary tissue product roll.

In one example, the sanitary tissue product of the present invention comprises a fibrous structure according to the present invention.

The sanitary tissue products and/or fibrous structures of the present invention may exhibit a basis weight of greater than 15 g/m² (9.2 lbs/3000 ft²) to about 120 g/m² (73.8 lbs/3000 ft²) and/or from about 15 g/m² (9.2 lbs/3000 ft²) to about 110 g/m² (67.7 lbs/3000 ft²) and/or from about 20 g/m² (12.3 lbs/3000 ft²) to about 100 g/m² (61.5 lbs/3000 ft²) and/or from about 30 (18.5 lbs/3000 ft²) to 90 g/m² (55.4 lbs/3000 ft²). In addition, the sanitary tissue products and/or fibrous structures of the present invention may exhibit a basis weight between about 40 g/m² (24.6 lbs/3000 ft²) to about 120 g/m² (73.8 lbs/3000 ft²) and/or from about 50 g/m² (30.8 lbs/3000 ft²) to about 110 g/m² (67.7 lbs/3000 ft²) and/or from about 55 g/m² (33.8 lbs/3000 ft²) to about 105 g/m² (64.6 lbs/3000 ft²) and/or from about 60 (36.9 lbs/3000 ft²) to 100 g/m² (61.5 lbs/3000 ft²).

The sanitary tissue products of the present invention may exhibit a total dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in). In addition, the sanitary tissue product of the present invention may exhibit a total dry tensile strength of greater than about 196 g/cm (500 g/in) and/or from about 196 g/cm (500 g/in) to about 394 g/cm (1000 g/in) and/or from about 216 g/cm (550 g/in) to about 335 g/cm (850 g/in) and/or from about 236 g/cm (600 g/in) to about 315 g/cm (800 g/in). In one example, the sanitary tissue product exhibits a total dry tensile strength of less than about 394 g/cm (1000 g/in) and/or less than about 335 g/cm (850 g/in).

In another example, the sanitary tissue products of the present invention may exhibit a total dry tensile strength of greater than about 196 g/cm (500 g/in) and/or greater than about 236 g/cm (600 g/in) and/or greater than about 276 g/cm (700 g/in) and/or greater than about 315 g/cm (800 g/in) and/or greater than about 354 g/cm (900 g/in) and/or greater than about 394 g/cm (1000 g/in) and/or from about 315 g/cm (800 g/in) to about 1968 g/cm (5000 g/in) and/or from about 354 g/cm (900 g/in) to about 1181 g/cm (3000 g/in) and/or from about 354 g/cm (900 g/in) to about 984 g/cm (2500 g/in) and/or from about 394 g/cm (1000 g/in) to about 787 g/cm (2000 g/in).

The sanitary tissue products of the present invention may exhibit an initial total wet tensile strength of less than about 78 g/cm (200 g/in) and/or less than about 59 g/cm (150 g/in) and/or less than about 39 g/cm (100 g/in) and/or less than about 29 g/cm (75 g/in).

The sanitary tissue products of the present invention may exhibit an initial total wet tensile strength of greater than about 118 g/cm (300 g/in) and/or greater than about 157 g/cm (400 g/in) and/or greater than about 196 g/cm (500 g/in) and/or greater than about 236 g/cm (600 g/in) and/or greater than about 276 g/cm (700 g/in) and/or greater than about 315 g/cm (800 g/in) and/or greater than about 354 g/cm (900 g/in) and/or greater than about 394 g/cm (1000 g/in) and/or from about 118 g/cm (300 g/in) to about 1968 g/cm (5000 g/in) and/or from about 157 g/cm (400 g/in) to about 1181 g/cm (3000 g/in) and/or from about 196 g/cm (500 g/in) to about 984 g/cm (2500 g/in) and/or from about 196 g/cm (500 g/in) to about 787 g/cm (2000 g/in) and/or from about 196 g/cm (500 g/in) to about 591 g/cm (1500 g/in).

The sanitary tissue products of the present invention may exhibit a density (measured at 95 g/in²) of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The sanitary tissue products of the present invention may be in the form of sanitary tissue product rolls. Such sanitary tissue product rolls may comprise a plurality of connected, but perforated sheets of fibrous structure, that are separably dispensable from adjacent sheets.

The sanitary tissue products of the present invention may comprise additives such as softening agents, temporary wet strength agents, permanent wet strength agents, bulk softening agents, lotions, silicones, wetting agents, latexes, especially surface-pattern-applied latexes, dry strength agents such as carboxymethylcellulose and starch, and other types of additives suitable for inclusion in and/or on sanitary tissue products.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

“Basis Weight” as used herein is the weight per unit area of a sample reported in lbs/3000 ft² or g/m² and is measured according to the Basis Weight Test Method described herein.

“Machine Direction” or “MD” as used herein means the direction parallel to the flow of the fibrous structure through the fibrous structure making machine and/or sanitary tissue product manufacturing equipment.

“Cross Machine Direction” or “CD” as used herein means the direction parallel to the width of the fibrous structure making machine and/or sanitary tissue product manufacturing equipment and perpendicular to the machine direction.

“Ply” as used herein means an individual, integral fibrous structure.

“Plies” as used herein means two or more individual, integral fibrous structures disposed in a substantially contiguous, face-to-face relationship with one another, forming a multi-ply fibrous structure and/or multi-ply sanitary tissue product. It is also contemplated that an individual, integral fibrous structure can effectively form a multi-ply fibrous structure, for example, by being folded on itself.

“Line element embossment” as used herein means an embossment that comprises a continuous line that has an aspect ratio of greater than 1.5:1 and/or greater than 1.75:1 and/or greater than 2:1 and/or greater than 5:1. In one example, the line element embossment exhibits a length of at least 2 mm and/or at least 4 mm and/or at least 6 mm and/or at least 1 cm to about 10.16 cm and/or to about 8 cm and/or to about 6 cm and/or to about 4 cm.

“Dot embossment” as used herein means an embossment that exhibits an aspect ratio of about 1:1. Non-limiting examples of dot embossments are embossments that are shaped like circles, squares and triangles.

“Design Element” as used herein means a discrete, object present on a surface of a fibrous structure. Non-limiting examples of design elements include representations of flowers, butterflies, animals, and geometric shapes. The discrete, object may comprise a primary design element and one or more secondary design elements. The primary and secondary design elements associate with each other to form the design element.

“Primary Design Element” as used herein means that portion of the design element that identifies what the design element is. It is an essential part of the design element. For example, the primary design element of a representation of a flower design element is the group of petals that form the essential part of the flower.

“Secondary Design Element” as used herein means that portion of the design element that is not essential to the design element. For example, the secondary design element may be a stem or branch off of a primary design element of a representation of a flower design element.

### Design Element

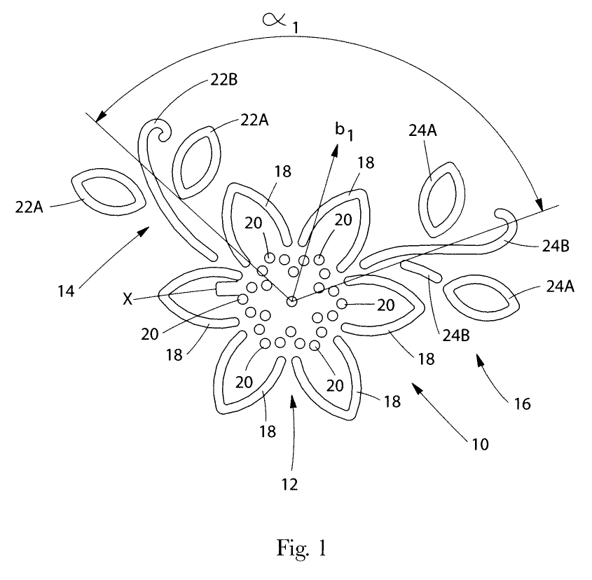

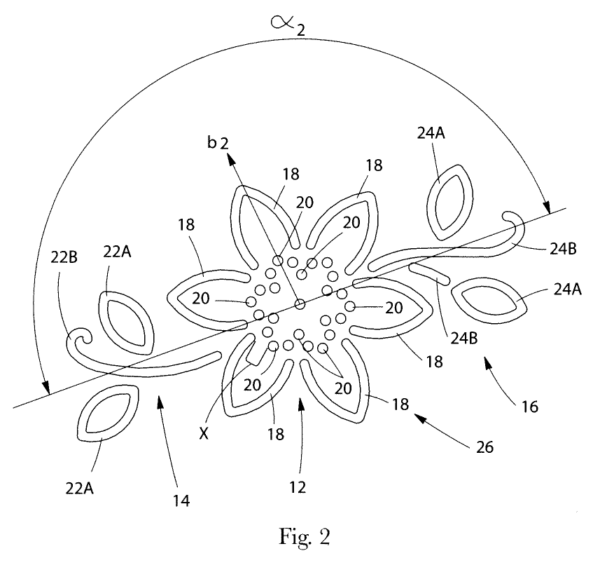

As shown in FIGS. 1 and 2, a design element 10, 26 comprises a primary design element 12 and two, different secondary design elements 14, 16. The primary design element 12 may comprise an essential part of a representation of a flower. The primary design element 12 may comprise one or more line element embossments 18. As is shown in FIGS. 1 and 2, the primary design element 12 may comprise one or more dot embossments 20. The dot embossments 20 may be substantially located within the center of the primary design element 12. The primary design element 12 may comprise line element embossments and/or dot embossments that may be arranged in a symmetrical manner, such as equal sized petals located at equal angular intervals and at an equal radial distance from the center of a flower. Alternatively, the primary design element 12 may comprise line element embossments and/or dot embossments that may be arranged in a non-symmetrical manner wherein at least one of the petal size, angular interval, and radial distance from the center of the flower, is different. In both the symmetrical and non-symmetrical arrangements, there is a maximum span X that is the greatest distance between any two embossments within the primary design element 12.

The ratio of surface area of the primary design element to a secondary design element may be greater than 1.2:1 and/or greater than 1.4:1 and/or greater than 1.5:1 and/or greater than 1.75:1. The surface area of the primary design element and/or the secondary design element is measured from the using the deflection points (the initial points of out-of-plane deflection) in the fibrous structures for the primary design element and/or secondary design elements.

Secondary design element 14 may comprise one or more line element embossments 22. The line element embossments 22 combine to form a stem with leaves. In addition to line element embossments 22, the secondary design element 14 may comprise one or more dot embossments (not shown).

Secondary design element 16 may comprise one or more line element embossments 24. The line element embossments 24 combine to form a stem with leaves. In addition to line element embossments 24, the secondary design element 16 may comprise one or more dot embossments (not shown).

The design element may comprise a plurality of different line element embossments. For example, the line element embossment may form an open loop 18, the line element embossment may form a closed loop 22A, 24A and/or the line element embossment may form a curvilinear element 22B, 24B. The line element embossments may be enclosed line element embossments (22A, 24A) and/or may be partially enclosed line element embossments (18).

As shown in FIG. 1, the two, different secondary design elements 14, 16 may be associated with each other via the primary design element 12 in design element 10 at an angle α₁ of greater than 100° to less than 180° and/or greater than 110° to less than 175° and/or greater than 120° to less than 175° and/or greater than 120° to less than 150° as measured according to the Secondary Design Element Angle Test Method. Without wishing to be bound by theory, it is believed that at least some consumers of fibrous structures comprising design elements of the present invention desire the design elements that have angles a of from about 100° to about 150° because they apparently believe the design elements look less “machined” and softer.

As shown in FIG. 2, the two, different secondary design elements 14, 16 are associated with each other via the primary design element 12 in design element 26 at an angle α₂ of greater than 155° to about 180° as measured according to the Secondary Design Element Angle Test Method and/or from greater than 160° to about 175° as measured according to the Secondary Design Element Angle Test Method.

The design element 10 may exhibit an orientation β₁, which is identified as a vector extending from the center of the primary design element 12 bisecting angle α₁.

The design element 26 may exhibit an orientation β₂, which is identified as a vector extending from the center of the primary design element 12 bisecting angle α₂.

The design element may comprise two or more and/or three or more secondary design elements. The secondary design elements may comprise the same shapes and/or different shapes of embossments, especially line element embossments.

In one example, the primary design element may exhibit reflection symmetry. In another example, the primary design element may exhibit rotational symmetry. In yet another example, the primary design element may exhibit both reflection and rotational symmetry. “Rotational symmetry” as used herein means rotational symmetry of order n, also referred to as n-fold rotational symmetry, or discrete rotational symmetry of the nth order, with respect to a particular point (in 2D) or axis (in 3D). Rotational symmetry as used herein means that rotation by an angle of 360°/n (180°, 120°, 90°, 72°, 60°, 51 3/7°, etc.) does not change the object. Note that 1-fold symmetry is no symmetry and 2-fold symmetry is the simplest symmetry.

In another example, the primary design element and at least one secondary design element comprise line element embossments where the primary design element's line element embossment exhibits a line element width that is different from the secondary design element's line element embossment's line element width. In one example the difference is greater than 2% and/or greater than 4% and/or greater than 6% and/or greater than 10% and/or greater than 15% and/or greater than 25%.

In yet another example, the primary design element and at least one secondary design element exhibits a difference in embossment height of 50 μm or greater and/or greater than 60 μm and/or greater than 75 μm and/or greater than 90 μm and/or greater than 100 μm as measured according to the Embossment Height Test Method, described herein.

The design elements and orientations of the design elements are made relative to a Cartesian coordinate system. Accordingly, the X- and Y-directions, which are the primary axes of the Cartesian coordinate system, are representative of the cross-machine and machine direction, respectively, relative to a fibrous structure comprising a design element of the present invention.

### Fibrous Structure

The fibrous structure of the present invention may comprise one or more design elements according to the present invention.

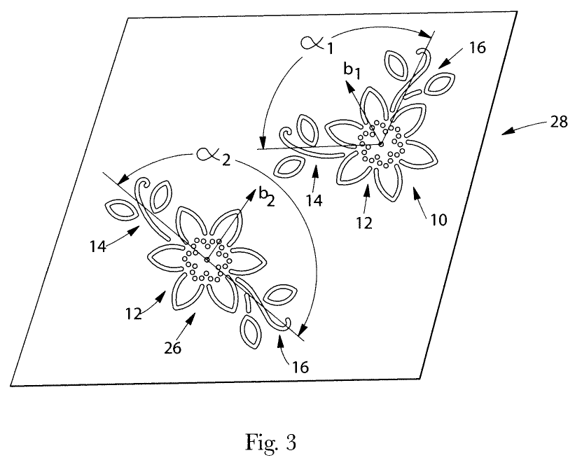

As shown in FIG. 3, a fibrous structure 28 of the present invention comprises a design element 10. The design element 10 comprises a primary design element 12 and two, different secondary design elements 14, 16, that are associated with each other via the primary design element 12 at an angle α₁ of greater than 100° but less than 175° and/or greater than 110° to less than 175° and/or greater than 120° to less than 175° and/or greater than 120° to less than measured according to the Secondary Design Element Angle Test Method.

The fibrous structure 28 may also comprise another design element 26 that is different from design element 10. Design element 26 may comprise a primary design element 12 and two, different secondary design elements 14, 16, that are associated with each other via the primary design element 12 at an angle α₂ of greater than 155° to about 180°.

In one example, the fibrous structure 28 comprises a plurality of design elements 10 and design elements 26. In another example, design elements 10 and design elements 26 may be present on a surface of the fibrous structure at a ratio of design element 10 to design element 26 greater than 1.5:1 and/or greater than 1.75:1 and/or greater than 2:1 and/or greater than 3:1.

In one example, the fibrous structure is in roll form. The fibrous structure may be convolutely wound about itself to form a roll or may be convolutely wound about a core to form a roll.

Even though the design elements 10, 26, comprise the same primary and second design elements as shown in FIG. 3, in another example, a fibrous structure may comprise two or more different design elements, wherein two or more of the different design elements comprise at least one different primary and/or secondary design element.

In another example, the fibrous structure may comprise a single design element rather than two or more different design elements. In another example, the fibrous structure may comprise different design elements having different angles α. For example, a fibrous structure may comprise a first design element having an angle α in the range of from greater than 100° to about 120° and a second design element having an angle α in the range of from greater than 125° to about 150°. In still another example, a fibrous structure may comprise different design elements having different angles a in the range of from greater than 100° to about 150°.

In addition to the design elements having different angles α, the fibrous structure of the present invention may comprise different design elements that exhibit different orientations β.

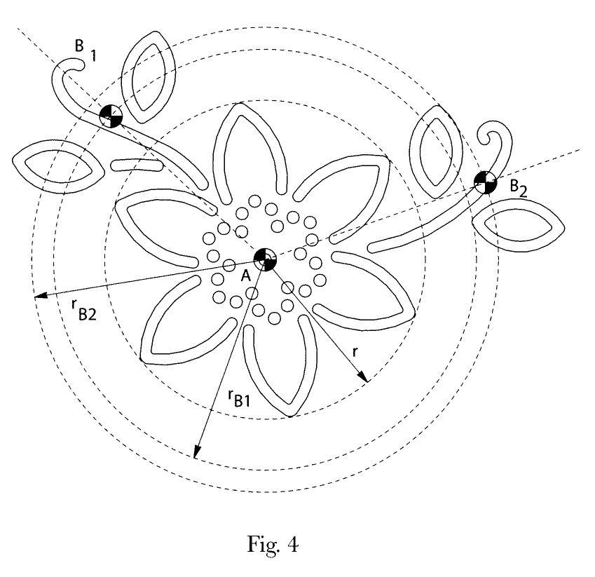

As shown in FIG. 4, another example of a fibrous structure of the present invention comprises a primary design element having a centroid A and two, different secondary design elements having centroids B₁ and B₂ that are associated with the primary design element, wherein the primary design element has a maximum span 2r between any two line element embossments within the primary design element and wherein the ratio of the average distance r_{B1} and r_{B2} between centroids B₁ and B₂ of the two secondary design elements from centroid A of the primary design element relative to the primary design element maximum span 2r is at least 0.4 to about 3 and/or at least 0.6 to about 2.5 and/or at least 0.6 to about 2.

### Method for Making a Fibrous Structure

The fibrous structures of the present invention may be made by any suitable process.

In one example, a fibrous structure according to the present invention is made by a method comprising the step of imparting a design element comprising a primary design element and two, different secondary design elements that are associated with each other via the primary design element at an angle of greater than 120° but less than 175° as measured according to the Secondary Design Element Angle Test Method to a fibrous structure.

In one example, the step of imparting a design element to a fibrous structure comprises contacting a molding member comprising a design element, with a fibrous structure such that the design element is imparted to the fibrous structure. The molding member may be a patterned belt that comprises a design element.

In another example, the step of imparting a design element to a fibrous structure comprises passing a fibrous structure through an embossing nip formed by at least one embossing roll comprising a design element such that the design element is imparted to the fibrous structure. An example of a suitable embossing operation may include a rubber-to-steel embossing operation.

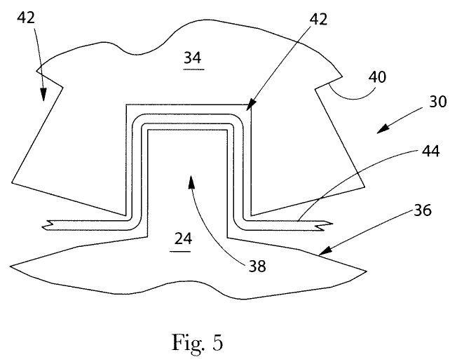

FIG. 5 shows an example of a suitable embossing operation for imparting a design element to a fibrous structure. As shown in FIG. 5, an embossing nip 30 comprising a first patterned roll 32 and a second patterned roll 34 is provided. The rolls 32 and 34 may comprise complementary or substantially complementary patterns. The first patterned roll 32 comprises a surface 36. The surface 36 may comprise one or more protrusions 38. The second patterned roll 34 comprises a surface 40. The surface 40 may comprise one or more recesses 42. At the embossing nip 30, one or more of the protrusions 38 of the surface 36 mesh with one or more of the recesses 42 of the surface 40. A fibrous structure 44 is positioned between one or more of the protrusions 38 of surface 36 and one or more of the recesses 42 of surface 40 at the embossing nip 30 and/or passes through the embossing nip 30 formed by the meshing of the protrusion 38 with the recess 42 during an embossing operation.

The embossing operation may apply a nip pressure, via the embossing nip, to the fibrous structure of less than about 80 pounds per lineal inch (pli) and/or less than about 60 pli and/or less than about 40 pli and/or less than 20 pli and/or less than about 10 pli to about 1 pli and/or to about 2 pli and/or to about 5 pli during creation of the embossment in the fibrous structure. In one example, the nip pressure in the embossing nip 34 when a fibrous structure is present within the embossing nip 34 is from about 2 pli to about 10 pli and/or from about 5 pli to about 10 pli.

The embossing operation of the process of the present invention and embossments made in the fibrous structure of the present invention may be phase registered with other features imparted in the fibrous structure.

### Non-Limiting Example

A fibrous structure in accordance with the present invention is prepared using a fibrous structure making machine having a layered headbox having a top chamber, a center chamber, and a bottom chamber. A eucalyptus fiber slurry is pumped through the top headbox chamber, a eucalyptus fiber slurry is pumped through the bottom headbox chamber (i.e. the chamber feeding directly onto the forming wire) and, finally, an NSK fiber slurry is pumped through the center headbox chamber and delivered in superposed relation onto the Fourdrinier wire to form thereon a three-layer embryonic web, of which about 33% of the top side is made up of the eucalyptus blended fibers, 33% is made of the eucalyptus fibers on the bottom side and 33% is made up of the NSK fibers in the center. Dewatering occurs through the Fourdrinier wire and is assisted by a deflector and vacuum boxes. The Fourdrinier wire is of a 5-shed, satin weave configuration having 87 machine-direction and 76 cross-machine-direction monofilaments per inch, respectively. The speed of the Fourdrinier wire is about 750 fpm (feet per minute).

The embryonic wet web is transferred from the Fourdrinier wire, at a fiber consistency of about 15% at the point of transfer, to a patterned drying fabric. The speed of the patterned drying fabric is the same as the speed of the Fourdrinier wire. The drying fabric is designed to yield a pattern comprising a continuous network of high density (knuckle) areas. This drying fabric is formed by casting an impervious resin surface onto a fiber mesh supporting fabric. The supporting fabric is a 45×52 filament, dual layer mesh. The thickness of the resin cast is about 11 mils above the supporting fabric.

Further de-watering is accomplished by vacuum assisted drainage until the web has a fiber consistency of about 20% to 30%.

While remaining in contact with the patterned drying fabric, the web is pre-dried by air blow-through pre-dryers to a fiber consistency of about 65% by weight.

After the pre-dryers, the semi-dry web is transferred to the Yankee dryer and adhered to the surface of the Yankee dryer with a sprayed creping adhesive. The creping adhesive is an aqueous dispersion with the actives consisting of about 22% polyvinyl alcohol, about 11% CREPETROL A3025, and about 67% CREPETROL R6390. CREPETROL A3025 and CREPETROL R6390 are commercially available from Hercules Incorporated of Wilmington, Del. The creping adhesive is delivered to the Yankee surface at a rate of about 0.15% adhesive solids based on the dry weight of the web. The fiber consistency is increased to about 97% before the web is dry creped from the Yankee with a doctor blade.

The doctor blade has a bevel angle of about 25 degrees and is positioned with respect to the Yankee dryer to provide an impact angle of about 81 degrees. The Yankee dryer is operated at a temperature of about 350° F. (177° C.) and a speed of about 750 fpm. The fibrous structure is wound in a roll using a surface driven reel drum having a surface speed of about 656 feet per minute. The fibrous structure is subjected to an embossing operation that imparts one or more line element embossments to a surface of the fibrous structure.

The fibrous structure may be subsequently converted into a two-ply sanitary tissue product having a basis weight of about 39 g/m². For each ply, the outer layer having the eucalyptus fiber furnish is oriented toward the outside in order to form the consumer facing surfaces of the two-ply sanitary tissue product.

The sanitary tissue product is soft, flexible and absorbent.

### Test Methods

Unless otherwise specified, all tests described herein including those described under the Definitions section and the following test methods are conducted on samples that have been conditioned in a conditioned room at a temperature of 73° F.±4° F. (about 23° C.±2.2° C.) a relative humidity of 50%±10% for 2 hours prior to the test. All plastic and paper board packaging materials must be carefully removed from the paper samples prior to testing. Discard any damaged product. All tests are conducted in such conditioned room.

### Basis Weight Test Method

Basis weight of a fibrous structure sample is measured by selecting twelve (12) usable units (also referred to as sheets) of the fibrous structure and making two stacks of six (6) usable units each. Perforation must be aligned on the same side when stacking the usable units. A precision cutter is used to cut each stack into exactly 8.89 cm×8.89 cm (3.5 in.×3.5 in.) squares. The two stacks of cut squares are combined to make a basis weight pad of twelve (12) squares thick. The basis weight pad is then weighed on a top loading balance with a minimum resolution of 0.01 g. The top loading balance must be protected from air drafts and other disturbances using a draft shield. Weights are recorded when the readings on the top loading balance become constant. The Basis Weight is calculated as follows:

$$Basis Weight ( lbs \text{/} 3000 {ft}^{2} ) = \frac{Weight of basis weight pad ( g ) \times 3000 {ft}^{2}}{\begin{matrix}453.6 g \text{/} lbs \times 12 ( usable units ) \times \\ [ \frac{12.25 {in}^{2} ( Area of basis weight pad )}{144 {in}^{2}} ]\end{matrix}}$$

$$Basis Weight ( g \text{/} {m}^{2} ) = \frac{Weight of basis weight pad ( \text{g} ) \times 10 , 000 {cm}^{2} \text{/} {m}^{2}}{\begin{matrix}79.0321 {cm}^{2} ( Area of basis weight pad ) \times \\ 12 ( usable units )\end{matrix}}$$

### Secondary Design Element Angle Test Method

The secondary design element angle formed between a primary design element and the secondary design elements of a design element is determined by the angle of the connections of the centroids of the secondary design elements with the centroid of the primary design element.

Each shape has a centroid in the x and y directions. The centroid of an area for a symmetrical object such as a square is located at the center of the object. For a complex object, the overall centroid is calculated by breaking the complex object into smaller, less complex objects, calculating the centroid of each smaller object, and then combining the centroids of the smaller objects, using a weighted average, to determine the centroid of the complex object. The calculation of centroid uses the following equation:

$$\begin{matrix}{A}_{T} \overline{x} = {\int }_{Area} x d A & ⇒ \overline{x} = \frac{1}{{A}_{T}} {\int }_{Area} x d A \\ {A}_{T} \overline{y} = {\int }_{Area} y d A & ⇒ \overline{y} = \frac{1}{{A}_{T}} {\int }_{Area} y d A\end{matrix}$$

where A_{T} is the total area and x̅ and y̅ are the centroid of the body. The equation can be broken into integrals of smaller areas:

$$\begin{matrix}{A}_{T} \overline{x} = \sum {\int }_{{A}_{i}} {x}_{i} d {A}_{i} & ⇒ \overline{x} = \frac{1}{{A}_{T}} \sum {\int }_{{A}_{i}} {x}_{i} d {A}_{i} \\ {A}_{T} \overline{y} = \sum {\int }_{{A}_{i}} {y}_{i} d {A}_{i} & ⇒ \overline{y} = \frac{1}{{A}_{T}} \sum {\int }_{{A}_{i}} {y}_{i} d {A}_{i}\end{matrix}$$

If each integral is replaced with its centroid and area, the centroid of the entire body can be computed using:

$$\begin{matrix}{\int }_{{A}_{i}} {x}_{i} d {A}_{i} = {\overline{x}}_{i} {A}_{i} & {\int }_{{A}_{i}} {y}_{i} d {A}_{i} = {\overline{y}}_{i} {A}_{i} \\ {A}_{T} \overline{x} = \sum {\overline{x}}_{i} {A}_{i} & ⇒ \overline{x} = \frac{1}{{A}_{T}} \sum {\overline{x}}_{i} {A}_{i} \\ {A}_{T} \overline{y} = \sum {\overline{y}}_{i} {A}_{i} & ⇒ \overline{y} = \frac{1}{{A}_{T}} \sum {\overline{y}}_{i} {A}_{i}\end{matrix}$$

By way of example, the secondary design element angle of an example of a design element comprising a primary design element A, a secondary design element B₁ and another secondary design element B₂, as shown in FIG. 6, of the present invention is measured by determining the centroids of the design element.

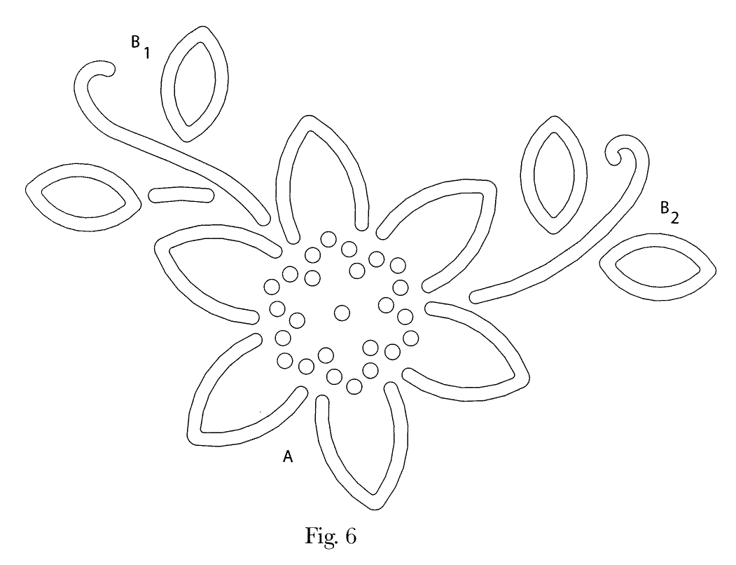

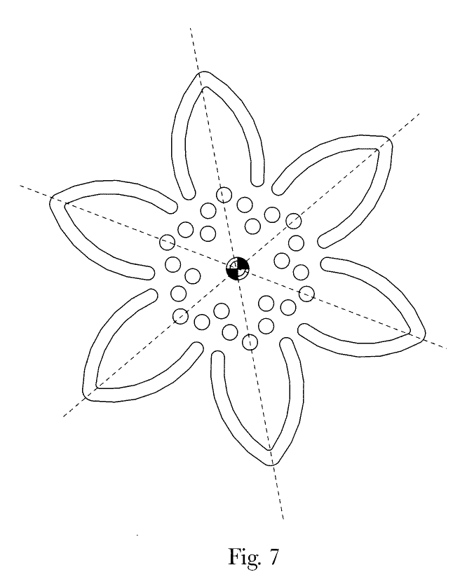

As the primary design element A is 6-fold symmetrical, the centroid is the intersecting point of all the symmetry axes, as shown in FIG. 7.

The centroids of the secondary design elements B₁ and B₂ are calculated by breaking each secondary design element into shapes with individual centroids and applying the following:

$$\begin{matrix}{A}_{T} \overline{x} = \sum {\overline{x}}_{i} {A}_{i} & ⇒ \overline{x} = \frac{1}{{A}_{T}} \sum {\overline{x}}_{i} {A}_{i} \\ {A}_{T} \overline{y} = \sum {\overline{y}}_{i} {A}_{i} & ⇒ \overline{y} = \frac{1}{{A}_{T}} \sum {\overline{y}}_{i} {A}_{i}\end{matrix}$$

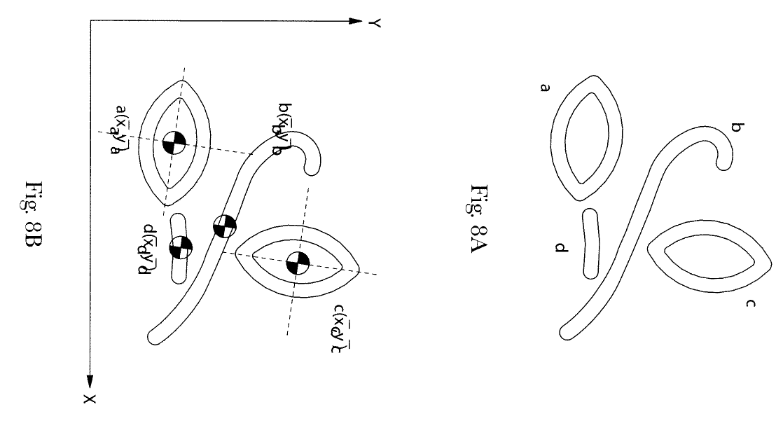

For secondary design element B₁, break it up into sub-secondary design elements a, b, c, and d, as shown in FIGS. 8A and 8B. Determine the area of each sub-secondary design element a, b, c, and d, and sum the areas for the sub-secondary design elements to arrive at the total area of the secondary design element B₁.

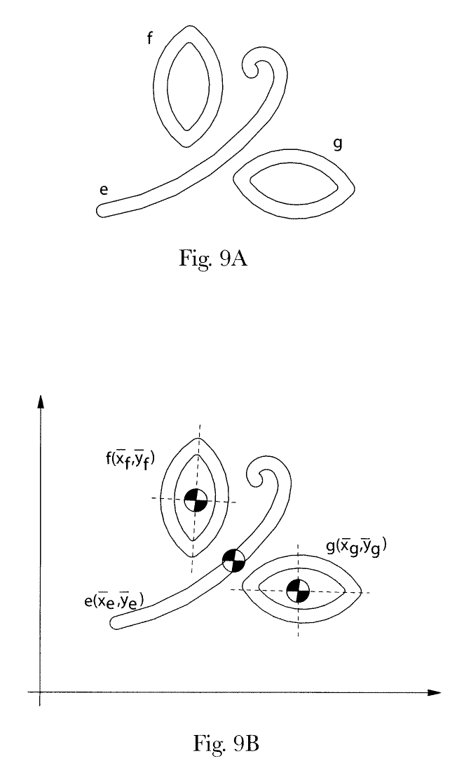

For secondary design element B₂, break it up into sub-secondary design elements e, f, and g, as shown in FIGS. 9A and 9B. Determine the area of each sub-secondary design element e, f, and g, and sum the areas for the sub-secondary design elements to arrive at the total area of the secondary design element B₂.

The centroids for the sub-secondary design elements a, c, f and g, which are shapes that have known centroids are determined as shown in FIGS. 8B and 9B.

The centroids for the sub-secondary design elements b, d and e, which are shapes that do not have known centroids, can be determined by calculating the centroid of a composed body as shown in FIGS. 8B and 9B.

The x̅ and y̅ centroid of each of the secondary design elements B₁ and B₂ are computed with the following equations.

$$\overline{x} = \frac{1}{{A}_{T}} \sum {\overline{x}}_{i} {A}_{i}$$

$$\overline{y} = \frac{1}{{A}_{T}} \sum {\overline{y}}_{i} {A}_{i}$$

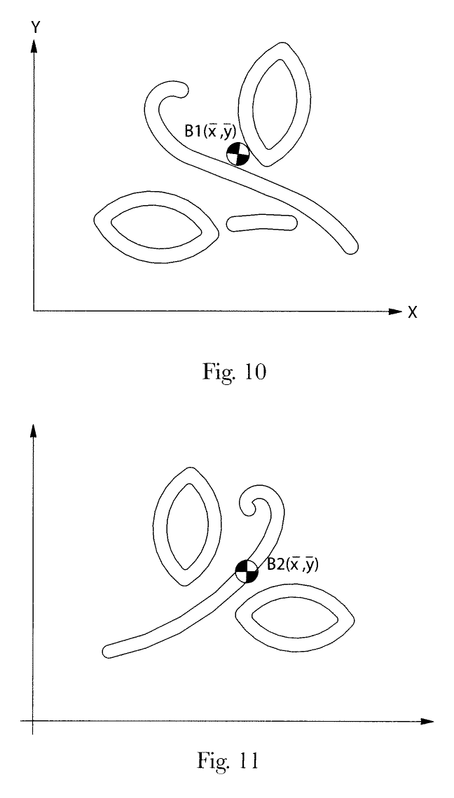

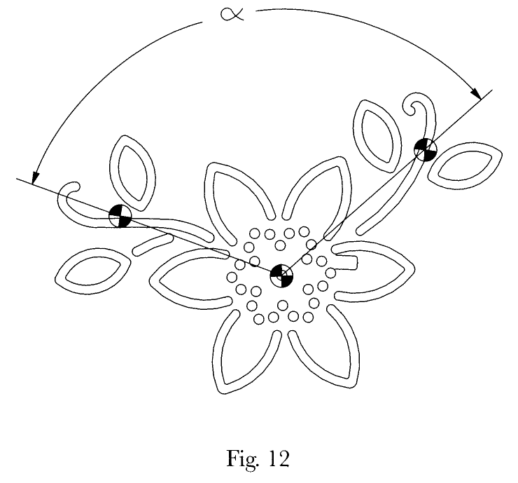

FIG. 10 shows the x̅ and y̅ centroid of secondary design element B₁. FIG. 11 shows the x̅ and the y̅ centroid of secondary design element B₂.

FIG. 12 shows the design element with the centroids for the primary and secondary design elements identified and the secondary design element angle of the design element.

### Embossment Height Test Method

The GFM Primos Optical Profiler system measures the surface height of a sample using the digital micro-mirror pattern projection technique. The result of the analysis is a map of surface height (z) vs. xy displacement. The system has a field of view of 27×22 mm with a resolution of 21 microns. The height resolution should be set to between 0.10 and 1.00 micron. The height range is 64,000 times the resolution.

To measure a fibrous structure sample do the following:
1. Turn on the cold light source. The settings on the cold light source should be 4 and C, which should give a reading of 3000K on the display;
2. Turn on the computer, monitor and printer and open the ODSCAD 4.0 Primos Software.
3. Select “Start Measurement” icon from the Primos taskbar and then click the “Live Pic” button.
4. Place a 30 mm by 30 mm sample of fibrous structure product conditioned at a temperature of 73° F.±2° F. (about 23° C.±1° C.) and a relative humidity of 50%±2% under the projection head and adjust the distance for best focus.
5. Click the “Pattern” button repeatedly to project one of several focusing patterns to aid in achieving the best focus (the software cross hair should align with the projected cross hair when optimal focus is achieved). Position the projection head to be normal to the sample surface.
6. Adjust image brightness by changing the aperture on the lens through the hole in the side of the projector head and/or altering the camera “gain” setting on the screen. Do not set the gain higher than 7 to control the amount of electronic noise. When the illumination is optimum, the red circle at bottom of the screen labeled “I.O.” will turn green.
7. Select Technical Surface/Rough measurement type.
8. Click on the “Measure” button. This will freeze on the live image on the screen and, simultaneously, the image will be captured and digitized. It is important to keep the sample still during this time to avoid blurring of the captured image. The image will be captured in approximately 20 seconds.
9. If the image is satisfactory, save the image to a computer file with “.omc” extension. This will also save the camera image file “.kam”.
10. To move the date into the analysis portion of the software, click on the clipboard/man icon.
11. Now, click on the icon “Draw Cutting Lines”. Make sure active line is set to line 1. Move the cross hairs to the lowest point on the left side of the computer screen image and click the mouse. Then move the cross hairs to the lowest point on the right side of the computer screen image on the current line and click the mouse. Now click on “Align” by marked points icon. Now click the mouse on the lowest point on this line, and then click the mouse on the highest point on this line. Click the “Vertical” distance icon. Record the distance measurement. Now increase the active line to the next line, and repeat the previous steps, do this until all lines have been measured (six (6) lines in total. Take the average of all recorded numbers, and if the units is not micrometers, convert it to micrometers (μm). This number is the embossment height. Repeat this procedure for another image in the fibrous structure product sample and take the average of the embossment heights.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fibrous structure comprising a design element comprising a primary design element and two, different secondary design elements that are associated with each other via the primary design element at an angle of greater than 100° but less than 180° as measured according to the Secondary Design Element Angle Test Method.

2. The fibrous structure according to claim 1 wherein the primary design element exhibits reflection symmetry.

3. The fibrous structure according to claim 1 wherein the primary design element exhibits rotational symmetry.

4. The fibrous structure according to claim 1 wherein the primary design element comprises a line element embossment.

5. The fibrous structure according to claim 1 wherein the primary design element comprises a dot embossment.

6. The fibrous structure according to claim 1 wherein the design element comprises a representation of a flower.

7. The fibrous structure according to claim 1 wherein at least one of the two, different secondary design elements comprises a line element embossment.

8. The fibrous structure according to claim 1 wherein the two, different secondary design elements are associated with each other via the primary design element at an angle of greater than 120° to about 150° as measured according to the Secondary Design Element Angle Test Method.

9. The fibrous structure according to claim 1 wherein the fibrous structure is in roll form.

10. A single- or multi-ply sanitary tissue product comprising a fibrous structure according to claim 1.

11. A fibrous structure comprising a first design element comprising a primary design element and two, different secondary design elements that are associated with each other via the primary design element at an angle of greater than 100° to about 150° as measured according to the Secondary Design Element Angle Test Method and a second design element different from the first design element, wherein the second design element comprises a primary design element and two, different secondary design elements that are associated with each other via the primary design element at an angle of greater than 155° to about 175° as measured according to the Secondary Design Element Angle Test Method.

12. The fibrous structure according to claim 11 wherein the ratio of the number of first design elements to the number of second design elements is greater than 1.5:1.

13. The fibrous structure according to claim 11 wherein the primary design element exhibits reflection symmetry.

14. The fibrous structure according to claim 11 wherein the primary design element exhibits rotational symmetry.

15. The fibrous structure according to claim 11 wherein the primary design element comprises a line element embossment.

16. The fibrous structure according to claim 11 wherein the primary design element comprises a dot embossment.

17. The fibrous structure according to claim 11 wherein at least one of the first and second design elements comprises a representation of a flower.

18. The fibrous structure according to claim 11 wherein at least one of the two, different secondary design elements comprises a line element embossment.

19. The fibrous structure according to claim 11 wherein the two, different secondary design elements are associated with each other via the primary design element at an angle of greater than 120° to about 150° as measured according to the Secondary Design Element Angle Test Method.

20. The fibrous structure according to claim 11 wherein the fibrous structure is in roll form.

21. A single- or multi-ply sanitary tissue product comprising a fibrous structure according to claim 11.

22. A fibrous structure comprising a primary design element and two, different secondary design elements associated with the primary design element, wherein the primary design element exhibits a embossment height of at least 50 μm or greater than the embossment height of the secondary design elements as measured according to the Embossment Height Test Method.

23. A fibrous structure comprising a primary design element and two, different secondary design elements associated with the primary design element, wherein the primary design element comprises a line element embossment having a first line element width and the secondary design elements comprising a line element embossment having a second line element width that is different from the first line element width.

24. A fibrous structure comprising a primary design element and two, different secondary design elements associated with the primary design element, wherein the primary design element has a maximum span between any two line element embossments within the primary design element and wherein the ratio of the average distance between centroids of the two secondary design elements from the centroid of the primary design element relative to the primary design element maximum span is at least 0.4 but less than 3.

25. A method for making a fibrous structure comprising a design element, the method comprising the step of imparting a design element comprising a primary design element and two, different secondary design elements that are associated with each other via the primary design element at an angle of greater than 120° but less than 175° as measured according to the Secondary Design Element Angle Test Method to a fibrous structure.

26. The method according to claim 25 wherein the step of imparting a design element comprises contacting a molding member comprising a design element with a fibrous structure such that the design element is imparted to the fibrous structure.

27. The method according to claim 25 wherein the step of imparting a design element comprises passing a fibrous structure through an embossing nip formed by at least one embossing roll comprising a design element such that the design element is imparted to the fibrous structure.
